(19) United States
(12) Patent Application Publication
(10) Pub. No.: US 2007/0291756 A1
(43) Pub. Date: Dec. 20, 2007

(54) Method and Apparatus for Providing Specialized Applications in a Network

(76) Inventors: Haseeb Akhtar, Garland, TX (US); Dan Caputo, Ottawa (CA); Larry Bolen, McKinney, TX (US); Azeem Ahmad, Allen, TX (US); Curtis Provost, Parker, TX (US); Carole Jacob, Ottawa (CA); James Weisert, Calgary (CA)

Correspondence Address: DOCKET CLERK, P.O. DRAWER 800889, DALLAS, TX, 75380, US

(21) Appl. No.: 10/590,624

(22) PCT Filed: Feb. 23, 2005
(86) PCT No.: PCT/US05/05602

§ 371 Date: May 14, 2007

Related U.S. Application Data
(60) Provisional application No. 60/547,297, filed on Feb. 24, 2004.

(51) Int. Cl. H04L 12/56

(52) U.S. Cl. 370/392

(57) ABSTRACT

In accordance with the teachings of the present invention, a method and apparatus is presented for identifying packet-based applications in a packet-based network. As such, the packet-based applications may receive specialized treatment.

### BACKGROUND OF THE INVENTION

1. Field of the Invention:

This invention relates to communications. Specifically, the invention relates to optimizing a network based on the user application operating on the network.

2. Description of the Prior Art:

Conventional communications networks often include both circuit-switched technologies and packet-switched technologies. Since circuit-switched networks were implemented first, many network applications are implemented to operate on circuit-switched networks and are not optimized for packet-switched networks. However, a wide variety of new applications are being implemented to take advantage of the efficiencies that can be gained when using packet-switched networks.

In addition to circuit-switched networks and packet-switched networks, wireless networks are also widely deployed. The wireless networks are often based on wireless network standards that define the interfaces between different components in the networks and the various packet formats that are used in the interfaces. For example, Second-Generation Wireless Network (2G) standards and Third-Generation Wireless Network (3G) standards are currently being deployed. Some of the more recent standards provide for multimedia traffic, such as voice and data traffic across these networks. Since these networks are also integrated into conventional circuit-switched and packet-switched networks, specialized multimedia applications that are driven by wireless technologies are now deployed across circuit-switched and packet-switched networks. For example, standards-based protocols, such as H.323 and Session Initiation Protocol (SIP), are currently being deployed to integrate multimedia functionality across wireless networks, circuit-switched networks, and packet-switched networks.

Given the need for ubiquitous communications, methods have developed for providing applications across wireless, packet-switched, and circuit-switched networks. However, depending on the type of network that the technology was initially deployed on, the technology may be optimized for one network, but may not be optimized for other types of network. In addition, very little network optimization is performed based on user applications. Instead, most optimization is performed based on the implementing technology.

Thus, there is a need for a method and apparatus for optimizing a network based on the technology. Further, there is a need to optimize a network based on user applications.

### SUMMARY OF THE INVENTION

A method and apparatus is presented for optimizing a packet-switched network based on user applications, such as Push-To-Talk (PTT), Voice-over-IP (VoIP), etc.

Currently, to establish a data call, a single A10 interface is established between a Packet Control Function (PCF of a base station (BS and a Packet Data Serving Node (PDSN) to transport user payloads, such as Internet Protocol (IP) packets. The A10 interface is established set up by sending signaling messages between the Packet Communication Facility (PCF) and a PDSN. The interface used for transporting the control plane (i.e., the signaling messages) between the PCF and the PDSN is known as the A11 interface. The A10 interface, the A11 interface, and other aspects of the present invention are defined in Interoperability Specification (IOS) for cdma2000 Access Network Interfaces Part 7—A10 and A11 Interfaces, 3G-IOSv4.3, 3GPP2 A.S0017-A, Version 2.0.1, http://www.3gpp2.org/Public_html/specs/A.S0017-A_v2.0.1 121903.pdf, July 2003, which is herein incorporated by reference.

In accordance with the teachings of the present invention, methods are presented to differentiate the content of the A10 interface (i.e., between the PCF and PDSN) based on the packet application to be transported across this interface. In one embodiment, the contents of the packet applications are differentiated as signaling packets and bearer packets. For example, real-time user applications (i.e., such as VoIP and PTT) may not require retransmission services provided by protocols, such as the Radio Link Protocol (RLP) as proposed by CDMA standards (i.e., such as TIA/EIA/IS-707). Taking away the RLP, however, may hinder the guaranteed delivery aspect of signaling messages and may significantly degrade the quality of the service. To ensure that the signaling packets are not lost, an A10 interface, implemented in accordance with the teachings of the present invention, separates the signaling packets so that they can be treated with higher priority than that of the bearer packets. Since a very small portion of the call/session holding time consists of signaling packets (i.e., such as SIP message for PTT), the chances of degrading the media quality (i.e., such as VoIP traffic for PTT) is fairly insignificant by treating the signaling packets with higher priority.

In one embodiment, the content of the A10 interface is differentiated by adding an extension in the A11-Registration Request message that is sent from the PCF to the PDSN informing the PDSN of the specialized application (i.e., such as PTT). In one embodiment, a Vendor Specific Extension (VSE) as specified in Dommety, G. and Leung, K. RFC 3025, Mobile IP Vendor/Organization-Specific Extensions, IETF, http://rfc.sunsite.dk/rfc/rfc3025.html, February 2001, which is incorporated herein by reference, can be used to add the extension to A11-Registration Request message.

A method for transporting both signaling messages and user payloads across a single A10 interface is presented. For example, a single A10 interface may be implemented as a channel for a Session Initiated Protocol (SIP)-based signaling messages for PTT as well as a channel for VoIP-based voice traffic for PTT. In accordance with the teachings of the present invention, this is accomplished by adding a flag (i.e., typically one toggle bit) in a Generic Routing Encapsulation (GRE) header to differentiate the specific application signaling (i.e., such as PTT SIP messages) from the user payload (i.e., such as the PTT VoIP traffic). The GRE is defined in Farinacci, et al., RFC 2784, Generic Routing Encapsulation (GRE), Internet Engineering Task Force, March 2000, which is herein incorporated by reference http://www.ietf.org/rfc/rfc2784.txt?number=2784).

A method is presented that uses Radio Link Protocol (RLP) to send application specific messages (i.e., such as PTT) between a Mobile Station (MS) and a BS. In one embodiment, PTT signaling messages (i.e., such as SIP messages for floor control) are sent as PTT Block Of Bits (PTT BLOB) between an MS and BS. The MS or the BS discovers that the user is running a specific application (i.e., such as PTT) and then sends signaling messages over the RLP (i.e., such as PTT BLOB) with a specific flag to designate these bits as a specialized message.

A method is presented that uses Short Data Burst (SDB) for delivering application specific signaling messages (i.e., such as SIP messages for PTT) to an MS while they are dormant. This is performed when the PCF receives a signaling message destined for a dormant MS and the PCF discovers that the MS is running a specific application (i.e., such as PTT) and decides to deliver the signaling message directly to the MS using the SDB feature. The SDB features are defined in Interoperability Specification (IOS) for High Rate Packet Data (HRPD) Access Network Interfaces 3 Revision 0, 3GPP2 A.S0008-0 v3. 0, http://www.3gpp2.org/Public_html/specs/A.S0008-0_v3.0. df, May 2003, which are herein incorporated by reference.

A method of operating a packet network, comprises the steps of processing a message in a standardized interface, the message including an indicia; and identifying a packet application in response to the indicia.

A method of operating a packet network, comprises the steps of communicating an A10 message including a generic routing encapsulation header; and identifying a type of message in response to the generic routing encapsulation header.

A method of identifying an application in a packet network, comprises the steps of identifying a user application; formulating a message including a flag, the flag identifying the user application; and communicating the message including the flag using a radio link protocol.

A method of operating a dormant MS, comprises the steps of receiving a signaling message; identifying a packet-based application in response to receiving the signaling message; and communicating the signaling message to a dormant MS using a short data burst.

A method of operating network, comprises the steps of receiving a reverse SDB from a dormant MS; and delivering the SDB to a PDSN using an A10 interface.

### BRIEF DESCRIPTION OF THE DRAWINGS

FIG. 1 displays a flow diagram detailing a method and apparatus for using application specific messages over an RLP layer.

FIG. 2 displays a flow diagram detailing a method and apparatus for implementing a combined signal and bearer A10.

FIG. 3 displays a message flow diagram detailing an information flow from the MS to the BS in accordance with the teachings of the present invention.

FIG. 4 displays a message flow diagram detailing an information flow from the BS to the MS in accordance with the teachings of the present invention.

FIG. 5 displays an example of a long A10 setup/update message implemented in accordance with the teachings of the present invention.

FIG. 6 displays an example of a short A10 setup/update message implemented in accordance with the teachings of the present invention.

FIG. 7 displays a flow diagram detailing a method and an apparatus implementing an SDB delivering information packets in accordance with the teachings of the present invention.

FIG. 8 displays a flow diagram detailing a generic method for implementing the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

A new interface between a Base Station (BS) and a Packet Data Service Node (PDSN) also know as A10 interface in the Code Division Multiple Access (CDMA) standards, such as 3^{rd} Generation Partnership Project (3GPP2), Telecommunications Industry Association (TIA), and Internet Engineering Task Force (IEET) is presented. During a data call, a single A10 interface is established to transport payload between the PCF of the BS and the PDSN. In accordance with the teachings of the present invention, several methods and network configurations are presented: 1) to differentiate the content of the A10 interface based on the packet application; 2) to transport both signaling messages and user payloads across the A10 interface; 3) to transport application specific messages between the MS and the BS using RLP; and 4) to deliver application specific messages to a dormant MS using SDB.

In one embodiment, a method of operating a packet network, comprises the steps of processing a message in a standardized interface, the message including an indicia that identifies a packet application. A variety of standardized interfaces that conform with the 3GPP2 project are presented and within the scope of the present invention. An indicia such as a special code placed in a message field (i.e., packet field) is implemented to identify packet applications. As such, specific types of applications may be distinguished and provided with specialized treatment. In accordance with the teachings of the present invention, packet applications include both signaling packets and payload packets. As such, using the methods and apparatus of the present invention, signaling packets and payload packets may be distinguished. In addition, packet applications include real-time packet applications that have time constraints to operate properly. Examples, of real-time packet applications include Push-to-Talk, Voice-over-IP, wireless internet messaging, real-time video, push-to-media, etc.

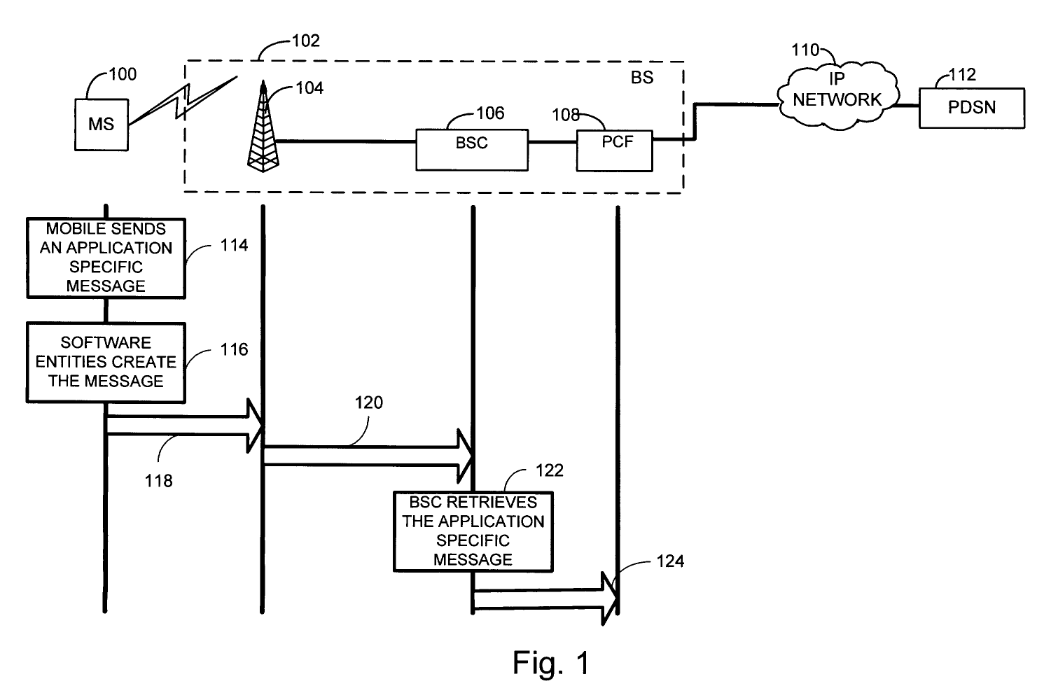

FIG. 1 displays a flow diagram detailing a method and apparatus for using application specific messages over an RLP layer. The message sequences detailed in FIG. 1 displays one embodiment for sending application specific messages (i.e., such as floor control messages for PTT application) as an RLP BLOB. In FIG. 1, an MS 100 is in communication with a BS 102. The BS 102 includes a BTS 104 in communication with a BSC 106, which is in communication with a PCF 108. The BS 102 is also in communication with an IP network 110. A PDSN 112 also communicates with the IP network 110.

During operation of the network depicted in FIG. 1, at step 114, the MS 100 sends an application specific message while it is in a packet data session (i.e., such as floor control messages for PTT application). As an example, this may happen if a PTT user pushes the button to seek the control of the floor during an active session. At step 116, software entities within the MS 100 (i.e., both the client and handset) create an application specific message as an application specific BLOB (i.e., such as PTT BLOB) for the RLP layer. The application specific BLOB is then attached to the RLP data packets destined for the BTS. At step 118, the MS 100 transmits the RLP packets with the application specific message (i.e., such as PTT BLOB for floor control messages) to the BTS 104. At step 120, the BTS 104 forwards the RLP packets with the application specific message (i.e., such as PTT BLOB for floor control messages) to the BSC. At step 122, the BSC 106 retrieves the application specific message (i.e., such as PTT BLOB for floor control messages) from the RLP packets. At step 124, the application specific BLOB (i.e., such as PTT BLOB) is forwarded as control packets to the PCF 108. The PCF 108 will continue to mark the control and the bearer packets separately using the methods described in the subsequent sections. The same sequence of events can be used in the reverse order for transporting an application specific message (i.e., such as PTT BLOB for floor control messages) from the BS (starting from the PCF) to the MS.

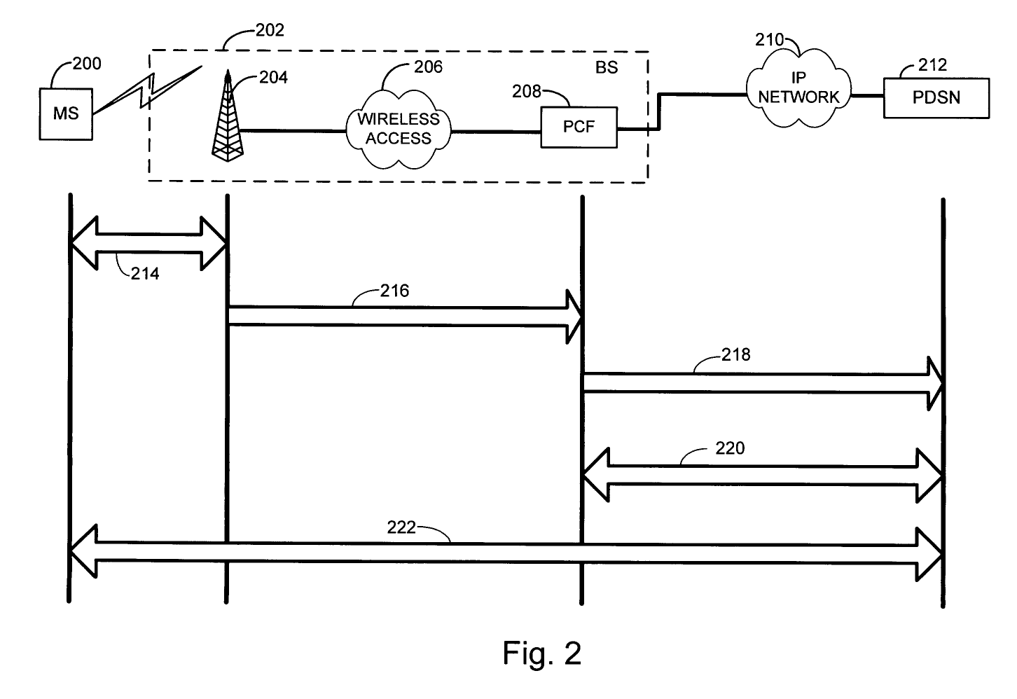

FIG. 2 displays a flow diagram detailing a method and apparatus for implementing a combined signal and bearer A10. In FIG. 2, one embodiment of a sequence for establishing A10 interface used for a specific packet-based application (i.e., such as PTT) is presented. In FIG. 2, an MS 200 is in communication with a BS 202. The BS 202 includes a BTS 204 in communication with a wireless access network 206, which is in communication with a PCF 208. The BS 202 is also in communication with an IP network 210. A PDSN 212 also communicates with the IP network 210.

During operation, at step 214, the MS 200 initiates a registration process for a specific packet-based application. At step 216, the PCF 208 is requested to setup an A10 interface between the PCF 208 and the PDSN 212. At step 218, the PCF 208 sends an A11-Registration message to the PDSN 212 indicating that this requested A10 interface will have different packet applications so that both signaling messages (i.e., such as SIP messages for PTT) and bearer plane (i.e., such as VoIP-based voice traffic for PTT) for serving this special user application (i.e., such as PTT). At step 220, the PCF 208 and the PDSN 212 set up a A10 interface for this special application (i.e., such as PTT) so that both control plane (i.e., such as SIP message for PTT) and the bearer plane (i.e., such as VoIP traffic for PTT) related to this application can be channeled through this A10 interface. As shown by 222, the MS 200 can now initiate the new packet-based application (i.e., such as PTT) across the wireless access network.

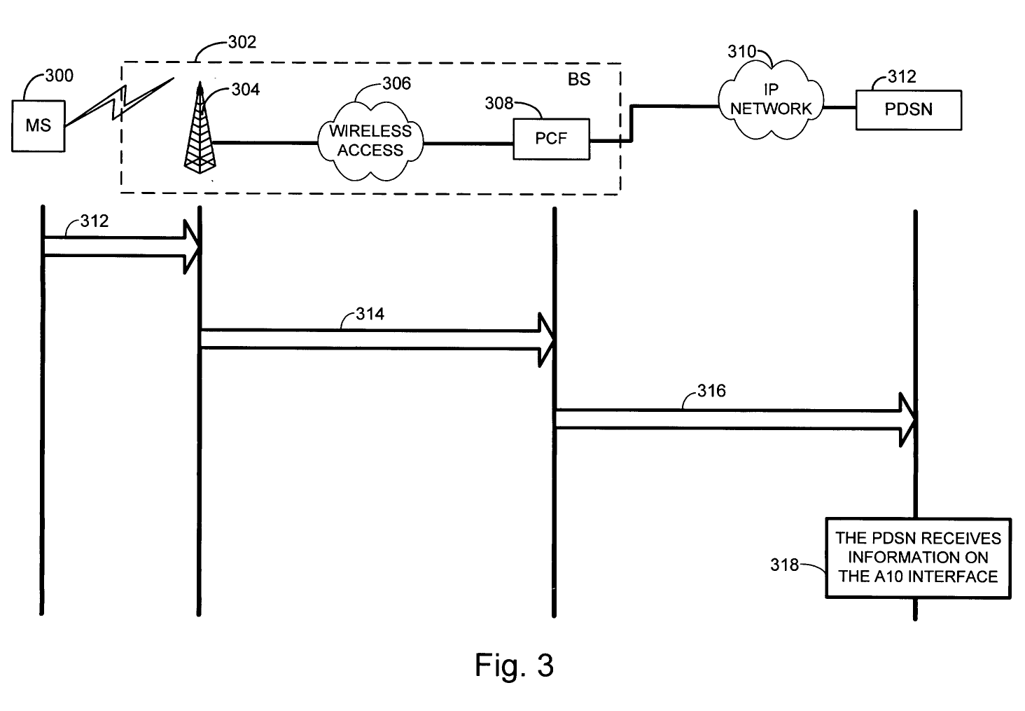

FIG. 3 displays a message flow diagram detailing an information flow from the MS to the BS in accordance with the teachings of the present invention. In FIG. 3, an MS 300 is in communication with a BS 302. The BS 302 includes a BTS 304 in communication with a wireless access network 306, which is in communication with a PCF 308. The BS 302 is also in communication with an IP network 310. A PDSN 312 also communicates with the IP network 310. At step 312, the MS 100 starts to send data packets (i.e., either signal or bearer) associated with a specific packet-based application (i.e., such as PTT) in a reverse direction, that is, towards the BS 302. Since the packets received by the BS 302 (i.e., from the MS 100) are all associated with a special packet-based application (i.e., such as PTT), in accordance with the teachings of the present invention, the BS 302 will mark the signaling and bearer packets separately (i.e., so that they can easily be identified) before shipping it to the PCF 308. At step 314, the BTS 304 forwards both the control bearer traffic associated with this application to the PCF 308 while marking them with special flags (i.e., indicia). The PCF 308 receives the packets associated with the special application (i.e., such as PTT) from the BS 302. The PCF 308 will then include a flag (i.e., indicia) in the GRE header to distinguish the signal plane (i.e., such as SIP messages for PTT) from the control plane (i.e., such as VoIP traffic for PTT) and ship it to the PDSN 312. As shown by 316, the PCF 308 first identifies whether the information to be sent over the A10 interface belongs to the signal plane or the control plane. The PCF 308 then marks the GRE header before shipping it to the PDSN 312. At 318, the PDSN 312 receives the packets associated with the special application (i.e., such as PTT) from the PCF 308. The PDSN 312 will then process the signaling plane (i.e., such as SIP messages for the PTT) and bearer plane (i.e., such as VoIP traffic for PTT) accordingly.

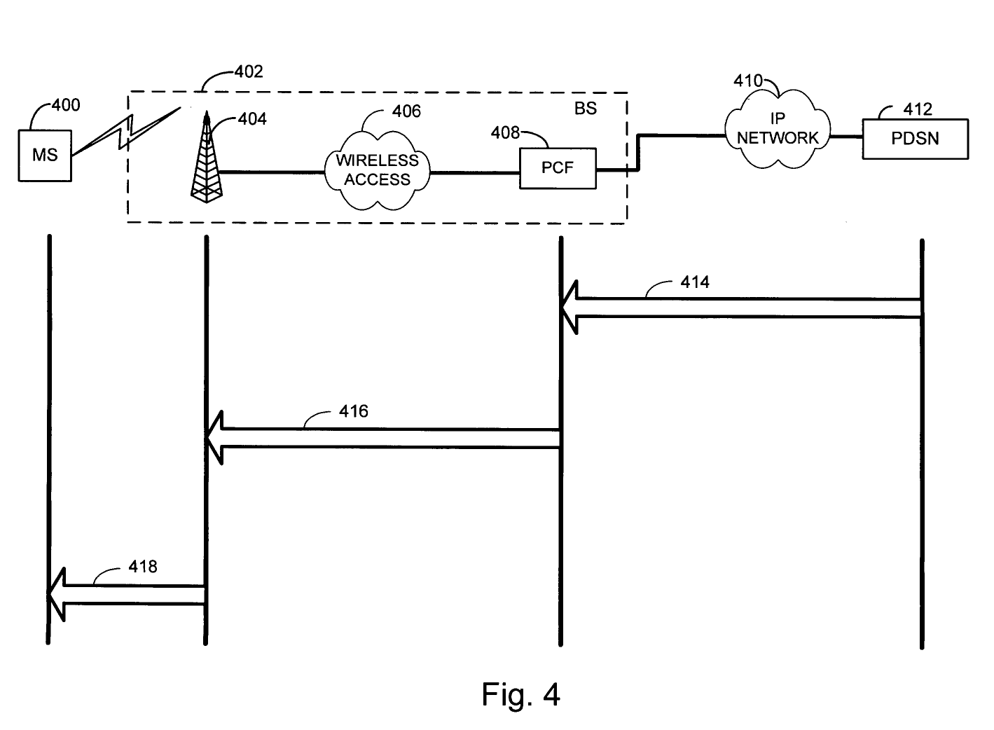

FIG. 4 displays a message flow diagram detailing an information flow from the BS to the MS in accordance with the teachings of the present invention. In FIG. 4, an MS 400 is in communication with a BS 402. The BS 402 includes a BTS 404 in communication with a wireless access network 406, which is in communication with a PCF 408.

At step 414, the IP-based packet network 410 sends information packets (i.e., messages) associated with a specific packet-based application (i.e., such as PTT) toward an MS 400. The PDSN 412 has to perform internal processing and interrogate the contents of the packet in order to determine how to mark the packet in the GRE header. The PDSN 412 then includes a flag in the GRE header so that the PCF 408 can distinguish the signal plane (i.e., such as SIP messages for PTT) from the control plane (i.e., such as VoIP traffic for PTT). The information packets associated with a specific application (i.e., such as PTT) are then shipped to the PCF 408.

As shown by 416, the PCF 408 receives the information packets from the PDSN 412 that are associated with a specific packet-based application (i.e., such as PTT). The PCF 408 first looks at the flag in the GRE header (i.e., as inserted by the PDSN 412) to determine if the information packets are signaling packets (i.e., such as SIP messages for PTT) or bearer packets (i.e., such as VoIP traffic for PTT). The PCF 408 then separates the signaling packets from the bearer packets and sends them to the BS 402.

As shown by 418, the BS 402 receives the information packets associated with a specific packet-based application (i.e., such as PTT) from the PCF 408. The BS 402 first separates the signaling plane (i.e., such as SIP messages for PTT) and the bearer plane (i.e., such as VoIP traffic for PTT) and then forwards them to the MS 400.

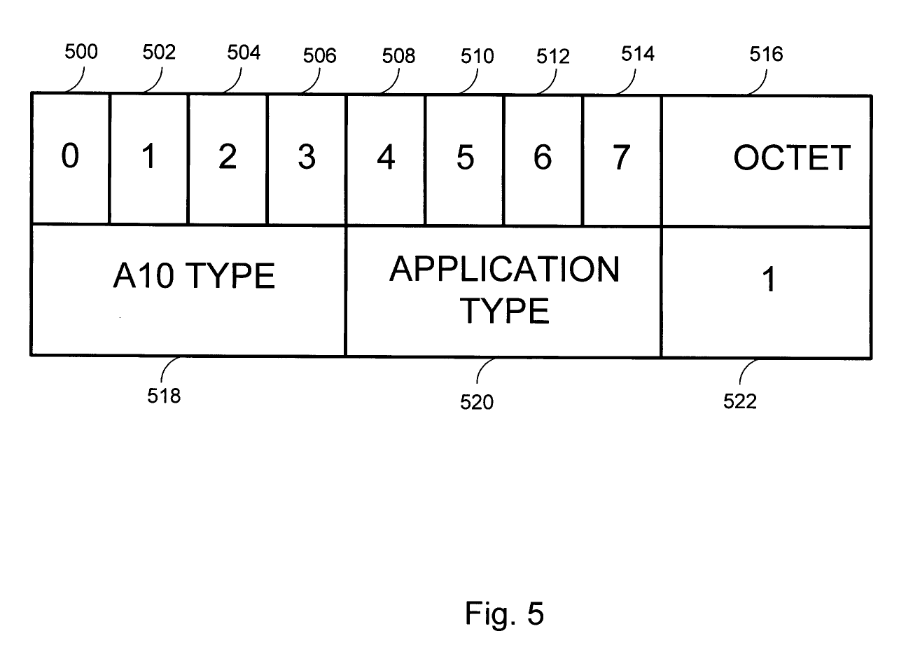

FIG. 5 displays an example of a long A10 setup/update message implemented in accordance with the teachings of the present invention. As shown in this FIG. 5, two additional fields (i.e., A10 type 518 and application type 520) are added to define a specialized A10 interface for a specific application. The A10 setup and/or update related messages, A11-Registration Request, A11-Registration Update, and A11-Session Update messages, which are defined in Interoperability Specification (IOS) for cdma2000 Access Network Interfaces Part 7-A10 and A11 Interfaces, 3G-IOSv4.3, 3GPP2 A.S0017-A, Version 2.0.1, http://www.3gpp2.org/Public_html/specs/A.S0017-A_v2.0.1_{—}121903.pdf, July 2003, will change to reflect an A10 interface that is capable of channeling both signal packets (i.e., such as SIP messages for PTT) and bearer packets (i.e., such as VoIP traffic for PTT). FIG. 5 displays an example of implementing the teachings of the present invention into A10 setup/update messages. The fields of the A10 message are displayed in FIG. 5. Bit location 0 is shown as 500, bit location 1 is shown as 502, bit location 2 is shown as 504, bit location 3 is shown as 506, bit location 4 is shown as 508, bit location 5 is shown as 510, bit location 6 is shown as 512, bit location 7 is shown as 514, octet shown as 516, A10 type is shown as 518, application type is shown as 520, and 1 is shown as 522. The A10 type 518 indicates the type of the A10 connection requested. In one embodiment, an A10 type 518 of 0 identifies an A10 interface for bearer traffic only. An A10 type 518 of 1 identifies an A10 interface for both signaling and bearer traffic. An A10 type 518 of 2-15 is reserved. The application type 520 indicates the specific application that is being supported. It should be appreciated that, in one embodiment of the present invention, fields such as application type 520 may be used as an indicia of the packet application (i.e., bearer, control plane, time-sensitive packet application, etc.).

In one embodiment, the application type 520 may be implemented as shown by the Table I:

| Application Type | Application |
|---|---|
| 0 | email |
| 1 | FTP |
| 2 | Telnet |
| 3 | Wireless Instant Messaging |
| 4 | PTT |
| 5 | VoIP |
| 6-15 | Reserved |

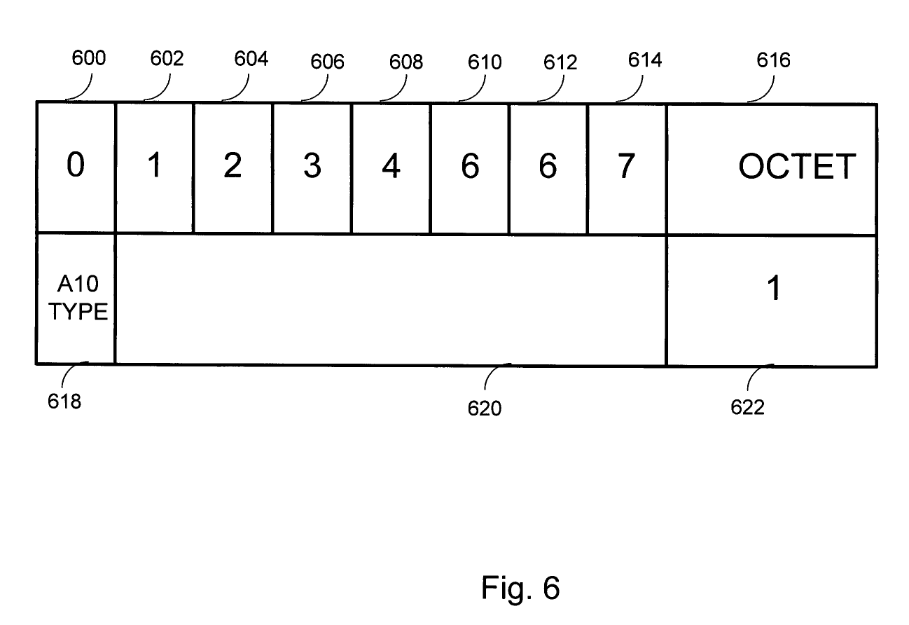

FIG. 6 displays an example of a short A10 setup/update message implemented in accordance with the teachings of the present invention. FIG. 6 displays a second embodiment of an A10 setup/update (i.e., A11-Registration Request, A11-Registration Update, and A11-Session Update) message implemented in accordance with the teachings of the present invention. As shown in FIG. 6, a single bit (i.e., A10 type 618) is used to differentiate between a conventional A10 format and an A10 format implemented in accordance with the teachings of the present invention. It should be appreciated that, in one embodiment of the present invention, a single field, such as the A10 type 618, may be used as indicia of the packet application (i.e., bearer, control plane, time-sensitive packet application, etc.).

A number of fields are shown in FIG. 6. Moving from the most significant bits to the least significant bits, bit location 0 shown as 600, bit location 1 is shown as 602, bit location 2 is shown as 604, bit location 3 is shown as 606, bit location 4 is shown as 608, bit location 5 is shown as 610, bit location 6 shown as 612, bit location 7 is shown as 614, octet shown as 616, A10 type shown as 618, bit locations shown by 620 are not defined, and bit location 1 is shown as 622. The A10 type 618 indicates the type of the A10 connection requested. In one embodiment, an A10 type 618 of 0 implements an A10 interface for bearer traffic only. An A10 type 618 of 1 implements an A10 interface for both signaling and bearer traffic.

During operation, a PDSN may perform the following actions upon receiving any of these messages (i.e., A11-Registration Request, A11-Registration Update, and A11-Session Update) implemented in accordance with the teachings for the present invention (i.e., FIG. 5 and/or FIG. 6):

1. upon receiving the A11-Registration Request message, the PDSN may set up the proposed A10 interface with the PCF;

2. upon receiving the A11-Registration Update message, the PDSN may update the necessary information to continue to maintain the proposed A10 interface with the PCF; and

upon receiving the A11-Session Update message, the PDSN may update the session associated with the propose A10 interface with the PCF.

The PDSN may create either an A10 interface as described in Interoperability Specification (IOS) for cdma2000 Access Network Interfaces Part 7—A10 and A11 Interfaces, 3G-IOSv4.3, 3GPP2 A.S0017-A, Version 2.0.1, http://www.3gpp2.org/Public_html/specs/A.S0017-A_v2.0.1_{—}121903.pdf, July 2003, or may create an A10 interface as proposed by this invention using any combination of A10 Type and Application Type fields received in these messages.

In accordance with the teachings of the present invention, a special flag in the GRE header is presented as part of the A10 interface when information packets are transported between the PDSN and the PCF. It should be appreciated that any of the reserved bits of the GRE header (i.e., as describe in Interoperability Specification (IOS) for High Rate Packet Data (HRPD) Access Network Interfaces 3 Revision 0, 3GPP2 A.S0008-0 v3. 0, http://www.3gpp2.org/Public_html/specs/A.S0008-0_v3.0pdf, May 2003,) may be used to convey the payload type. For example, in one embodiment the flags may be implemented as follows:
0=Payload if the GRE packet is carrying signal packets (i.e., such as SIP messages for PTT);
1=Payload if the GRE packet is carrying bearer packets (i.e., such as VoIP traffic for PTT)
   In a second embodiment, the Protocol Type field of the GRE header may also be used to implement the flag identified above in a similar manner.

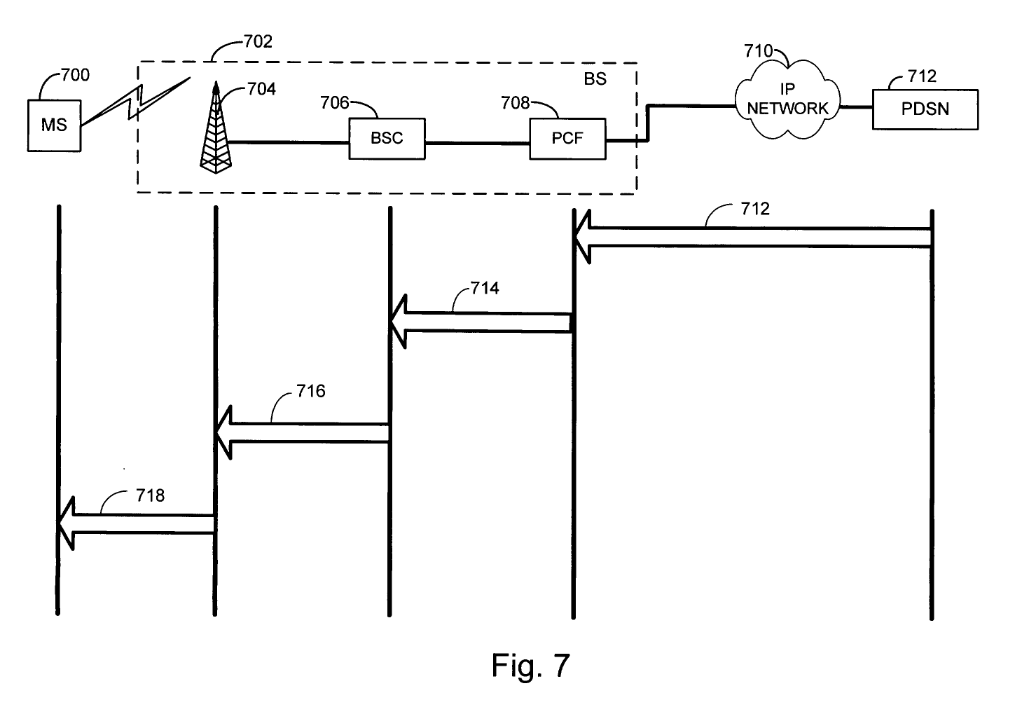

FIG. 7 displays a flow diagram detailing a method and an apparatus implementing an SDB delivering information packets in accordance with the teachings of the present invention. In accordance with the teachings of the present invention, a BS uses an SDB to deliver information packets associated with a specific application to any MS that may have gone dormant. In FIG. 7, an MS 700 is in communication with a BS 702. The BS 702 includes a BTS 704 in communication with a BSC 706, which is in communication with a PCF 708. The BS 702 is also in communication with an IP network 710. A PDSN 712 also communicates with the IP network 710.

At 712, the PDSN sends information packets associated with a specific packet-based application (i.e., such as PTT) to the PCF 708. The information packets are destined for an MS that is currently registered in the wireless access network (i.e., FIG. 7). At step 714, the PCF 708 processes the information packets associated with a specific application (i.e., such as PTT) and forwards them to the BSC 706. The PCF 708 identifies the information packets as a control message and marks it as such for the BSC 706. At 716, the BSC 706 receives the information packets associated with a specific application (i.e., such as PTT) and identifies the destined MS's location, that is, the location of the BTS 704 currently serving the MS 700. The BSC 706 also discovers that the MS 700 is currently in a dormant state. Since the BSC 706 knows that the information is a control message associated with a specific application (i.e., such as PTT), it will forward the data packets as an SDB. The BSC 706 then instructs the appropriate BTS 704 to deliver the information packets to the MS 100 using SDB. The BTS 704 receives the information packets destined for the MS 700. The BTS 704 then delivers the information packets to the MS 700 using the SDB, as shown by 718. An SDB received from the MS can also be delivered to the PDSN using the same sequences in the reverse order.

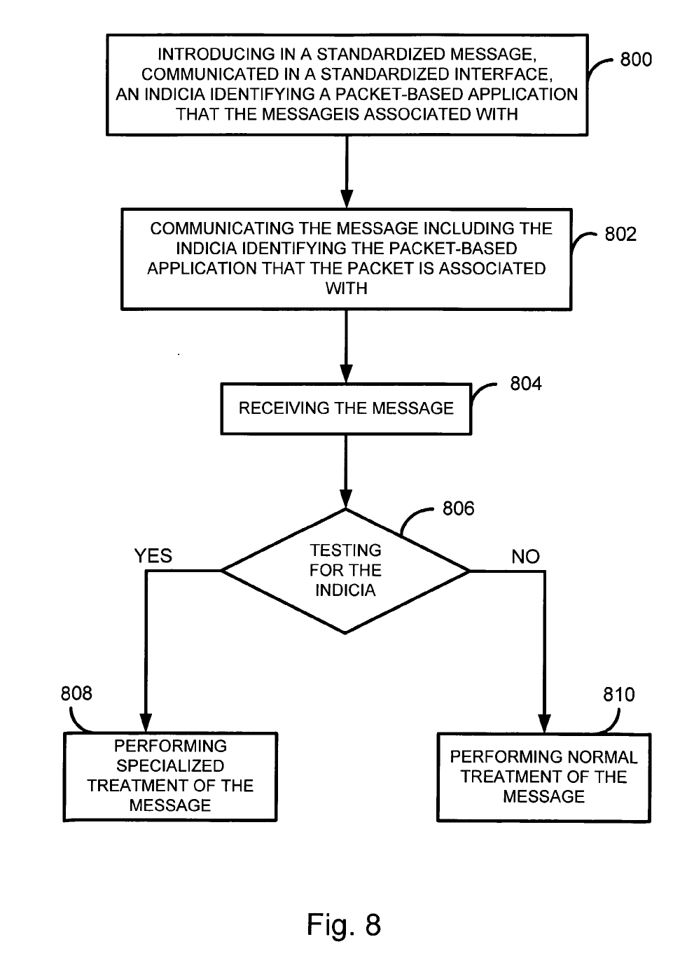

FIG. 8 displays a flow diagram detailing a generic method for implementing the teachings of the present invention. In accordance with the teachings of the present invention, each of the foregoing methods and architectures detailed in FIGS. 1-7 present a method for identifying specific packet-based applications in a network. In one embodiment, control plane messages are distinguished from bearer messages in a packet network. In a second embodiment, time-sensitive packet-based applications are identified in a network. As such, the specific packet-based applications may be distinguished in the network and given specialized treatment.

In FIG. 8, an indicia identify a packet-based application that the packet is associated with is introduced in a standardized message that is then communicated in a standardized interface as stated at 800. In accordance with the teachings of the present invention, a packet-based application is defined as a control plane message, a bearer message, and/or a time-sensitive packet-based application, such as PTT, VoIP, etc. A standardized message includes any message or signaling that is implemented in one of the standardized interfaces. The standardized interfaces include the interfaces defined in Interoperability Specification (IOS) for cdma2000 Access Network Interfaces Part 7, 3G-IOSv4.3, 3GPP2 A.S0017-A, Version 2.0.1, http:/www.3gpp2.org/Public_html/specs/A.S0017-A_v2.0.1_{—}121903.pdf, July 2003. For example, standardized packet network interfaces include an A1 interface, an A2 interface, an A3 interface, an A4 interface, an A5 interface, an A6 interface, an A7 interface, an A8 interface, an A9 interface, an A10 interface, and an A11 interfaces and the associated messages are defined in the Interoperability Specification (IOS) for cdma2000 Access Network Interfaces Part 7, which is herein incorporated by reference generally and specifically for the purposes of defining the interfaces, signaling, and messaging formats associated with the interfaces.

The A1 interface carries signaling information between the Call Control (CC) and Mobility Management (MM) functions of the MSC and the call control component of the BS (BSC). The A3 interface is used for inter-BS soft/softer handoff when a target BS is attached to the frame selection function within the source BS. The A3 interface carries coded user information (voice/data) and signaling information between the SDU function and the channel element component of the BS (BTS). This is a logical description of the endpoints of the A3 interface. The physical endpoints are beyond the scope of this specification. The A3 interface is composed of two parts: signaling and user traffic. The signaling information is carried across a separate logical channel from the user traffic channel and controls the allocation and use of channels for transporting user traffic.

The A7 interface carries signaling information between a source BS and a target BS. The A7 interface is used between the source BS and the target BS for inter-BS soft/softer handoff. The A8 interface carries user traffic between the BS and the PCF. The A8 interface is used to provide a path for user traffic between source BSC and PCF for packet data services. The A9 interface carries signaling information between the BS and the PCF. The A9 interface is used to provide a signaling connection between source BSC and PCF for packet data services. The A10 interface carries user traffic between the PCF and the PDSN. The A10 interface is used to provide a path for user traffic between a PCF and a PDSN for packet data services. The A11 interface carries signaling information between the PCF and the PDSN. This is a logical architecture that does not imply any particular physical implementation. The A11 interface is used to provide a signaling connection between a PCF and a PDSN for packet data services.

At step 802, the message including the indicia identifying the packet-based application is communicated. The message may be communicated from an MS, a BTS, a Call Processor (CP), a Routing Manager (RM), a Routing Agent (RA), a BSS, a BSC, an MSC, a PCF, an IP-based network, or a PDSN depending on the interface. In addition, the message may be communicated between networks. At step 804, the message is received. The message may be received in an MS, a BTS, a CP, a RM, a RA, a BSS, a BSC, an MSC, a PCF, an IP-based network, or a PDSN depending on the interface. In addition, the message may be received in one network from another network. A test is then made at the receiving point as stated at 806. The test is made to determine if the message includes the indicia. If the message does include the indicia, the message is given specialized treatment as stated at 808. Specialized treatment may involve performing additional processes, providing priority service, etc. If the message does not include the indicia, the message is not given specialized treatment as stated at 810.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A method of operating a packet network, comprising the steps of:
processing a message in a standardized interface, the message including an indicia; and
identifying a packet application in response to the indicia.

2. A method of operating a packet network, as set forth in claim 1, wherein the standardized interface is an A1 interface.

3. A method of operating a packet network, as set forth in claim 1, wherein the standardized interface is an A3 interface.

4. A method of operating a packet network, as set forth in claim 1, wherein the standardized interface is an A5 interface.

5. A method of operating a packet network, as set forth in claim 1, wherein the standardized interface is an A7 interface.

6. A method of operating a packet network, as set forth in claim 1, wherein the standardized interface is an A9 interface.

7. A method of operating a packet network, as set forth in claim 1, wherein the standardized interface is an A10 interface.

8. A method of operating a packet network, as set forth in claim 1, wherein the standardized interface is an A11 interface.

9. A method of operating a packet network, as set forth in claim 1, wherein the packet application is a control plane packet application.

10. A method of operating a packet network, as set forth in claim 1, wherein the packet application is a bearer packet application.

11. A method of operating a packet network, as set forth in claim 1, wherein the packet application is a push-to-talk packet application.

12. A method of operating a packet network, as set forth in claim 1, wherein the packet application is a Voice-over-IP packet application.

13. A method of operating a packet network, as set forth in claim 1, wherein the packet application is a delay-sensitive packet application.

14. A method of operating a packet network, comprising the steps of:
communicating an A10 message including a generic routing encapsulation header; and
identifying a type of message in response to the generic routing encapsulation header.

15. A method of operating a packet network, as set forth in claim 14, wherein the type of message is a control message.

16. A method of operating a packet network, as set forth in claim 14, wherein the type of message is a bearer message.

17. A method of identifying an application in a packet network, comprising the steps of:
identifying a user application;
formulating a message including a flag, the flag identifying the user application; and
communicating the message including the flag using a radio link protocol.

18. A method of identifying an application in a packet network, as set forth in claim 17, wherein the user application is a PTT application and the message is a PTT block of bits.

19. A method of operating a dormant MS, comprising the steps of:
receiving a signaling message;
identifying a packet-based application in response to receiving the signaling message; and
communicating the signaling message to a dormant MS using a short data burst.

20. A method of operating a dormant MS, as set forth in claim 19, wherein the method is performed in a PCF.

21. A method of operating network, comprising the steps of:
receiving a reverse SDB from a dormant MS; and
delivering the SDB to a PDSN using an A10 interface.
